(19) United States
(12) Patent Application Publication
(10) Pub. No.: US 2015/0058482 A1
(43) Pub. Date: Feb. 26, 2015

(54) SYSTEM INSIGHT DISPLAY

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: MING YU, Shenzhen (CN)

(21) Appl. No.: 14/467,694

(22) Filed: Aug. 25, 2014

(30) Foreign Application Priority Data
Aug. 26, 2013 (CN) 2013103750819

(51) Int. Cl. H04L 12/26; G06F 17/21

(52) U.S. Cl. CPC H04L 43/045; G06F 17/212
USPC 709/224

(57) ABSTRACT

A system insight display includes a complex programmable logic device (CPLD), a network connecting module, and a baseboard management controller (BMC). The CPLD monitors a plurality of states of a plurality of function components. The BMC connects the CPLD through a predefined bus. The BMC can receive information corresponding to the plurality of states from the CPLD and establish a user interface to indicate the plurality of states. The BMC can respond to a display request from a remote computer through the network connecting module to display information regarding the plurality of states to the user interface.

### FIELD

The present disclosure relates to a system insight display.

### BACKGROUND

A Systems Insight Display (SID) represents a system board layout to enable diagnosis working states of some function modules, such as processor, memory, fans, power supply, internal temperature, and network in a server. A plurality of SID LEDS can indicate working states of function modules. A traditional SID is integrated in a board, and is connected to a motherboard through cables. It is a waste to use an extra board to show the working states of the function modules.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is a block view of an example embodiment of a computer system.

FIG. 2 is a view of a user interface according to an example embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

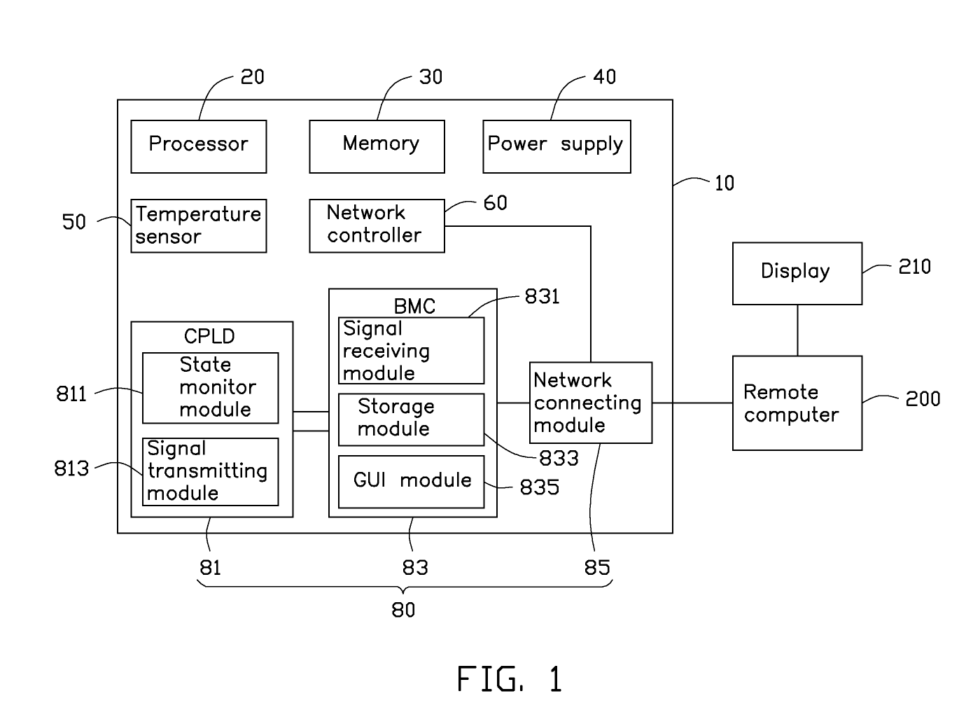

FIG. 1 illustrates an example embodiment of a block view of a computer system. The computer system includes a motherboard 10, a processor 20, a memory 30, a power supply 40, a temperature sensor 50, a network controller 60, and system insight display 80. The processor 20, the memory 30, the power supply 40, the temperature sensor 50, the network controller 60, and the system insight display (SID) 80 are connected to the motherboard 10.

The system insight display 80 includes a complex programmable logic device (CPLD) 81, a baseboard management controller (BMC) 83, and a network connecting module 85. The computer system can also include fans and peripheral component interconnect card.

The CPLD 81 is a programmable logic device with complexity between that of programmable array logic (PAL) and field-programmable gate array (FPGA), and architectural features of both. Main building block of the CPLD is a microcell, which contains logic implementing disjunctive normal form expressions and more specialized logic operations. The CPLD 81 is electrically connected to the processor 20, the memory 30, the power supply 40, the temperature sensor 50, and the network controller 60. The CPLD 81 includes a state monitor module 811 and a signal transmitting module 813. The state monitor module 811 can monitor a plurality of states of the processor 20, the memory 30, the power supply 40, the temperature sensor 50, and the network controller 60. The signal transmitting module 813 can send the plurality of states to the BMC 83.

The BMC 83 is a part of the intelligent platform management interface (IPMI). The BMC 83 is a specialized microcontroller embedded in the motherboard 10, generally a server. The BMC 83 manages the interface between system management software and platform hardware. The BMC 83 includes a signal receiving module 831, a storage module 833, and a graphical user interface (GUI) module 835. The signal receiving module 831 is electronically connected to the signal transmitting module 813 through a predefined bus, such as a universal asynchronous receiver and transmitter (UART) bus, a serial peripheral interface (SIP) bus, and an inter-integrated circuit (I²C) bus. The GUI module 835 can establish a user interface indicating the plurality of states. The user interface can be created by hypertext markup language (HTML) and can simulate a physical layout of the processor 20, the memory 30, the power supply 40, the temperature sensor 50, and the network controller 60. The user interface can set different colors to indicate the states of the processor 20, the memory 30, the power supply 40, the temperature sensor 50, and the network controller 60, for example, green indicates normal and red indicates error.

The network connecting module 85 can be a wireless connector or a RJ45 connector. The BMC 83 is electrically connected to the network connecting module 85. The network connecting module 85 can be connected to a remote computer 200. The remote computer 200 includes a display 210. The BMC 83 can respond to a display request from the remote computer 200 through the network connecting module 85 to display information regarding the plurality of states to the user interface. The remote computer 200 can display the user interface on the display 210. The BMC 83 can define a predefined internet protocol address, so that the BMC 83 can indicate if the display request is from a device with the predefined internet protocol address.

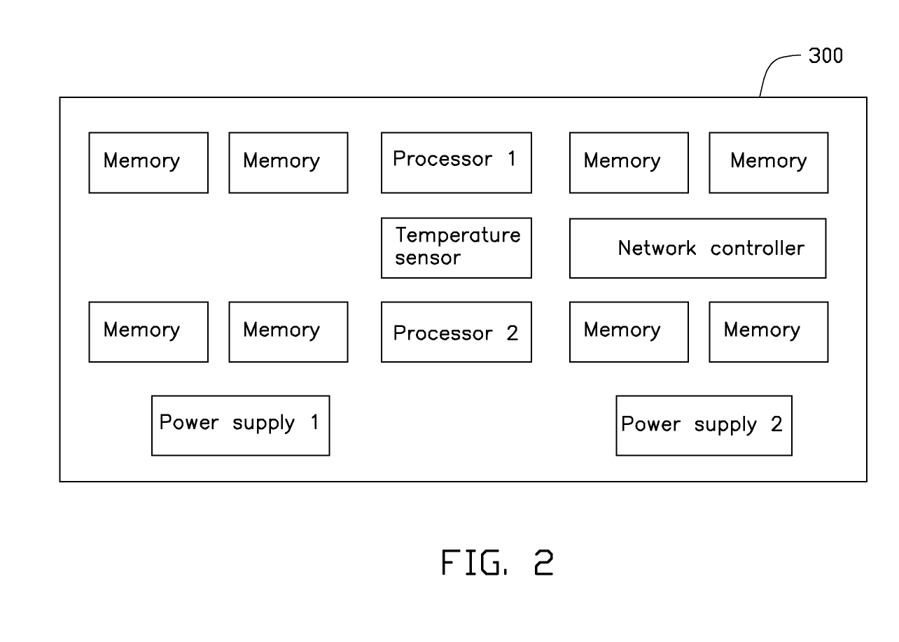

FIG. 2 illustrates a view of the user interface 300 showing the states of a plurality of components. The displayed layout in the user interface corresponds to the physical layout of the plurality of components.

The SID 80 can establish the user interface without wires or cables, the states can be intuitively shown on the display 210. The remote computer 200 can also monitor a plurality of servers simultaneously.

Even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. A system insight display, comprising:
a complex programmable logic device (CPLD) for monitoring a plurality of states of a plurality of function components;
a network connecting module; and
a baseboard management controller (BMC) connecting the CPLD through a predefined bus, the BMC being configured to receive information corresponding to the plurality of states from the CPLD, establish a user interface to indicate the plurality of states of the plurality of function components, and respond to a display request from a remote computer through the network connecting module to display information regarding the plurality of states to the user interface.

2. The system insight display of claim 1, wherein the predefined bus is a universal asynchronous receiver and transmitter bus.

3. The system insight display of claim 1, wherein the predefined bus is a serial peripheral interface bus.

4. The system insight display of claim 1, wherein the predefined bus is an inter-integrated circuit bus.

5. The system insight display of claim 1, wherein the BMC is configured to respond to the display request from a predefined internet protocol address.

6. The system insight display of claim 1, wherein the network connecting module is a wireless connector.

7. The system insight display of claim 1, wherein the network connecting module is a RJ45 connector.

8. The system insight display of claim 1, wherein the user interface is configured to simulate physically layout of the plurality of function components.

9. The system insight display of claim 1, wherein the user interface is configured to indicate the plurality of states in different colors.

10. A system insight display, comprising:
a complex programmable logic device (CPLD) for monitoring a plurality of states of a plurality of function components; and
a baseboard management controller (BMC) connecting the CPLD through a predefined bus, the BMC being configured to receive information corresponding to the plurality of states from the CPLD, the BMC comprising a graphic user interface (GUI) module, the GUI module is configured to establish a user interface to indicate the plurality of states of the plurality of function components and display information regarding the plurality of states to the user interface.

11. The system insight display of claim 10, wherein the predefined bus is a universal asynchronous receiver and transmitter bus.

12. The system insight display of claim 10, wherein the predefined bus is a serial peripheral interface bus.

13. The system insight display of claim 10, wherein the predefined bus is an inter-integrated circuit bus.

14. The system insight display of claim 10, further comprising a network connecting module, wherein the BMC is electrically connected to the network connecting module and is configured to respond to a display request from a remote computer through the network connecting module to output the user interface.

15. The system insight display of claim 14, wherein the BMC is configured to respond to the display request from a predefined internet protocol address.

16. The system insight display of claim 14, wherein the network connecting module is a wireless connector.

17. The system insight display of claim 14, wherein the network connecting module is a RJ45 connector.

18. The system insight display of claim 10, wherein the user interface is configured to simulate physically layout of the plurality of function components.

19. The system insight display of claim 10, wherein the user interface is configured to indicate the plurality of states in different colors.
